(19) United States
(12) Patent Application Publication
(10) Pub. No.: US 2009/0073051 A1
(43) Pub. Date: Mar. 19, 2009

(54) FLAT DUAL-BAND ANTENNA

(76) Inventor: Ming-Yen LIU, Taipei (TW)

Correspondence Address: Muncy, Geissler, Olds & Lowe, PLLC, P.O. BOX 1364, FAIRFAX, VA, 22038-1364, US

(21) Appl. No.: 12/202,810

(22) Filed: Sep. 2, 2008

(30) Foreign Application Priority Data
Sep. 14, 2007 (CN) 200710149474.2
Sep. 14, 2007 (TW) 096134484

(51) Int. Cl. H01Q 1/38

(52) U.S. Cl. 343/700 MS

(57) ABSTRACT

A flat dual-band antenna includes a radiating unit, a grounding unit and a feeding unit. One end of the grounding unit is connected with the radiating unit, and the other end of the grounding unit is grounded. The grounding unit has a gradual width-changing section. The radiating unit is divided into a first radiating portion and a second radiating portion by the grounding unit. The feeding unit is connected with the junction of the first and second radiating portions, and electrically connected with the radiating unit and the grounding unit.

### CROSS REFERENCE TO RELATED APPLICATIONS

This Non-provisional application claims priority under 35 U.S.C. §119(a) on Patent Application No(s). 096134484 filed in Taiwan, Republic of China on Sep. 14, 2007, the entire contents of which are hereby incorporated by reference.

### BACKGROUND OF THE INVENTION

1. Field of Invention

The invention relates to a dual-band antenna and, in particular, to a flat dual-band antenna.

2. Related Art

Wireless transmission technology is widely used in electronic products. Most present electronic products have the wireless transmission function so as to satisfy customers' requirements. The antenna is an important element for transmitting and receiving electromagnetic waves in the wireless transmission systems. Without the antenna, the wireless transmission system cannot transmit and receive data. Thus, the antenna plays an indispensable role in the wireless transmission system.

To select an appropriate antenna can make the product appearance more attractive, enhance the transmission quality and reduce the product cost. Different methods and different materials for manufacturing the antennas are used in different products. In addition, the antennas are designed in consideration of different frequency bands used in different countries.

As shown in FIG. 1, a flat single-band antenna 1 includes a radiating unit 11, a grounding unit 12 and a feeding unit 13. The flat single-band antenna 1 is disposed on a circuit board 14. The grounding unit 12 is protruded from one end of the radiating unit 11, and the feeding unit 13 is protruded from one point of the radiating unit 11. The grounding unit 12 and the feeding unit 13 are disposed at the same side of the radiating unit 11. The grounding unit 12 is grounded, and the feeding unit 13 is for feeding signals.

The flat single-band antenna 1 can operate in a frequency band, which is, for example, compliant with IEEE 802.11b/g (2.4 GHz) or IEEE 802.11a (5 GHz), according to the radiating unit 11. However, the flat single-band antenna 1 is not enough for the present multi-band applications.

Therefore, it is an important subject to provide a flat dual-band antenna that can operate in dual frequency bands to enhance the transmission efficiency.

### SUMMARY OF THE INVENTION

An object of the invention is to provide a flat dual-band antenna that can operate in dual frequency bands.

To achieve the above object, the invention discloses a flat dual-band antenna, which includes a radiating unit, a grounding unit and a feeding unit. The grounding unit has a gradual width-changing section. One end of the grounding unit is connected with the radiating unit, and the other end of the grounding unit is grounded. The radiating unit is divided into a first radiating portion and a second radiating portion by the grounding unit. The feeding unit is connected with the junction of the first radiating portion and the second radiating portion, and electrically connected with the radiating unit and the grounding unit.

As mentioned above, the flat dual-band antenna of the invention modifies the relative location of the feeding unit and the configuration of the grounding unit, so that the first radiating portion and the grounding unit can operate in a first frequency band and the second radiating portion and the grounding unit can operate in a second frequency band. In addition, the impedance can be adjusted by the gradual width-changing section of the invention so as to increase the operating frequency bandwidth. Therefore, the flat dual-band antenna of the invention can operate in dual frequency bands and have larger bandwidth, thereby enhancing the transmission efficiency.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view of a conventional flat single-band antenna;

FIG. 2 is a schematic view of a flat dual-band antenna according to a preferred embodiment of the invention;

FIG. 3 is a schematic view of another flat dual-band antenna according to the preferred embodiment of the invention;

FIG. 4 is a schematic diagram showing the Return Loss of the flat dual-band antenna according to the preferred embodiment of the invention;

FIGS. 5A to 5C are schematic diagrams showing the radiation fields of X-Y plane, X-Z plane and Y-Z plane, respectively, when the flat dual-band antenna according to the preferred embodiment of the invention operates at 2.4 GHz; and

FIGS. 6A to 6C are schematic diagrams showing the radiation fields of X-Y plane, X-Z plane and Y-Z plane, respectively, when the flat dual-band antenna according to the preferred embodiment of the invention operates at 5.8 GHz.

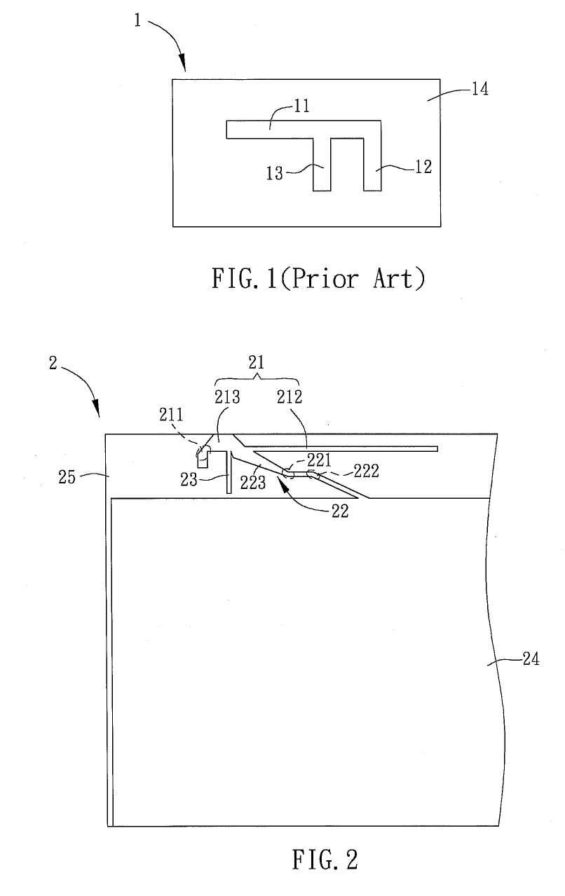

### DETAILED DESCRIPTION OF THE INVENTION

The present invention will be apparent from the following detailed description, which proceeds with reference to the accompanying drawings, wherein the same references relate to the same elements.

As shown in FIG. 2, a flat dual-band antenna 2 according to a preferred embodiment of the invention includes a radiating unit 21, a grounding unit 22 and a feeding unit 23. The radiating unit 21, the grounding unit 22 and the feeding unit 23 are integrally formed in the embodiment.

The radiating unit 21 may have at least one bending portion 211. The bending portion 211 can efficiently reduce the occupied area of the radiating unit 21 so as to contribute the miniaturization of the antenna. If there is no configuration of the bending portion 211, the radiating unit 21 can be strip-shaped. Alternatively, the radiating unit 21 can be L-shaped with the bending portion 211. Of course, the shape of the radiating unit 21 is not limited and can be any other shapes.

One end of the grounding unit 22 is connected with the radiating unit 21, and the other end of the grounding unit 22 is connected with a grounding surface 24 and grounded. In the embodiment, an angle is formed between the grounding unit 22 and the radiating unit 21, and the angle can be an acute or obtuse angle. The grounding unit 22 may have at least one bending portion. In the embodiment, the grounding unit 22 has two bending portions 221 and 222.

In addition, the grounding unit 22 has a gradual width-changing section 223. According to the gradual width-changing section 223, the width of the grounding unit 22 can be gradually increased or decreased for adjusting the impedance, thereby increasing the operating bandwidth. The gradual width-changing section 223 of the embodiment is disposed adjacent to the radiating unit 21 and is gradually decreased. Moreover, the radiating unit 21 is divided into a first radiating portion 212 and a second radiating portion 213 by the grounding unit 22.

The feeding unit 23 is connected with the junction of the first radiating 212 and the second radiating portion 213, and electrically connected with the radiating unit 21 and the grounding unit 22. The feeding unit 23 and the grounding unit 22 are disposed at the same side of the radiating unit 21. In the embodiment, the combination of the radiating unit 21 and the feeding unit 23 is T-shaped. In addition, the junction of the feeding unit 23 and the radiating unit 21 is disposed adjacent to the junction of the grounding unit 22 and the radiating unit 21. The flat dual-band antenna 2 of the embodiment can operate in dual frequency bands by adjusting the relative locations of the feeding unit 23 and the grounding 22.

The flat dual-band antenna 2 further includes a substrate 25. The radiating unit 21, the grounding unit 22, the feeding unit 23 and the grounding surface 24 are disposed on the substrate 25. The substrate 25 can be a printed circuit board (PCB).

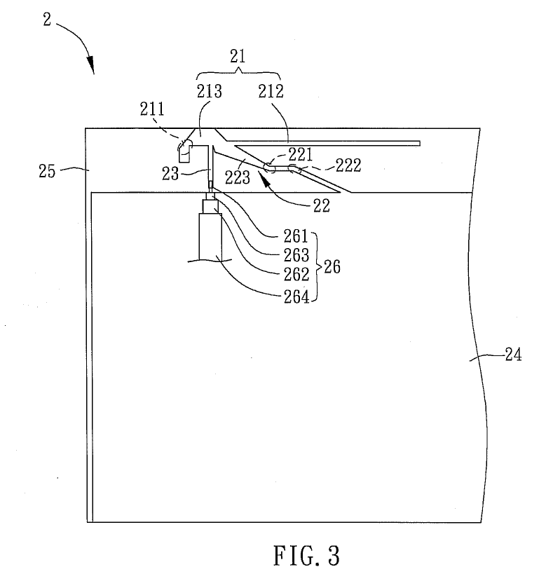

As shown in FIG. 3, the flat dual-band antenna 2 further includes a conductive unit 26, such as a coaxial transmission cable. The conductive unit 26 has a conductive body 261 and a grounding body 262. The conductive body 261 is electrically connected with the feeding unit 23, and the grounding body 262 is grounded. The grounding body 262 is connected with the grounding surface 24 and grounded. The conductive unit 26 further includes a first insulating layer 263 and a second insulating layer 264. The first insulating layer 263 is disposed between the conductive body 261 and the grounding body 262 to insulate electrical signals between the conductive body 261 and the grounding body 262. The second insulating layer 264 is the surface layer of the conductive unit 26 for providing insulation and protection functions. Of course, besides the conductive unit 26, the traces on the substrate 25 can also alternatively provide the signal feeding function.

In the embodiment, the first radiating portion 212 and the grounding unit 22 operate in a first frequency band, and the second radiating portion 213 and the grounding unit 22 operate in a second frequency band. The first frequency band, for example, is compliant with IEEE 802.11b/g with an operating bandwidth between 2.4 GHz and 2.5 GHz. The second frequency band, for example, is compliant with IEEE 802.11a with an operating bandwidth between 5.2 GHz and 5.8 GHz.

To be noted, the skilled persons in this art should know that the operating frequency band of the antenna is related to its dimension, and the dimension can be adjusted according to the operating frequency band of the antenna. For example, the dimension of the antenna could be adjusted by the rule as follows. The resonance length of the antenna can be a quarter (for dipole antenna) or a half wavelength (for patch antenna) of the operating frequency band. In other words, when the dimension of the antenna is adjusted, the operating frequency band of the antenna is correspondingly changed.

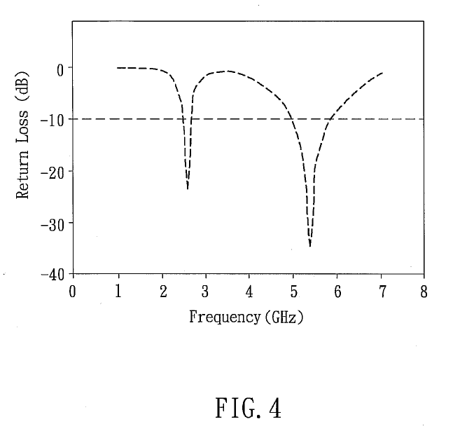

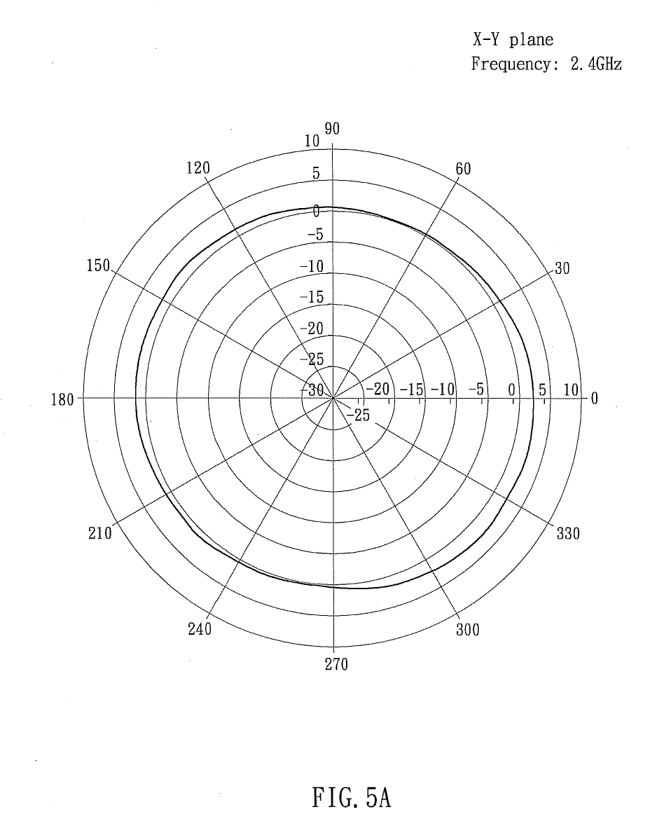

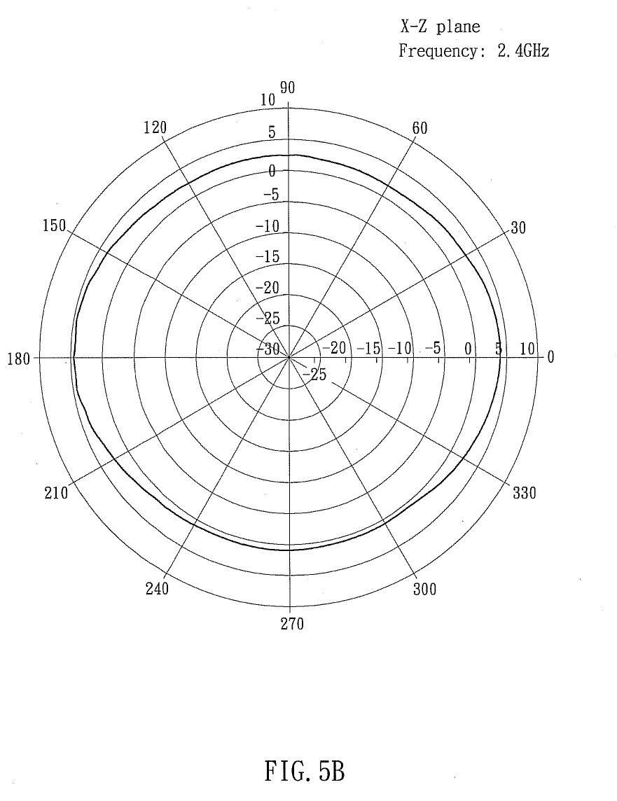

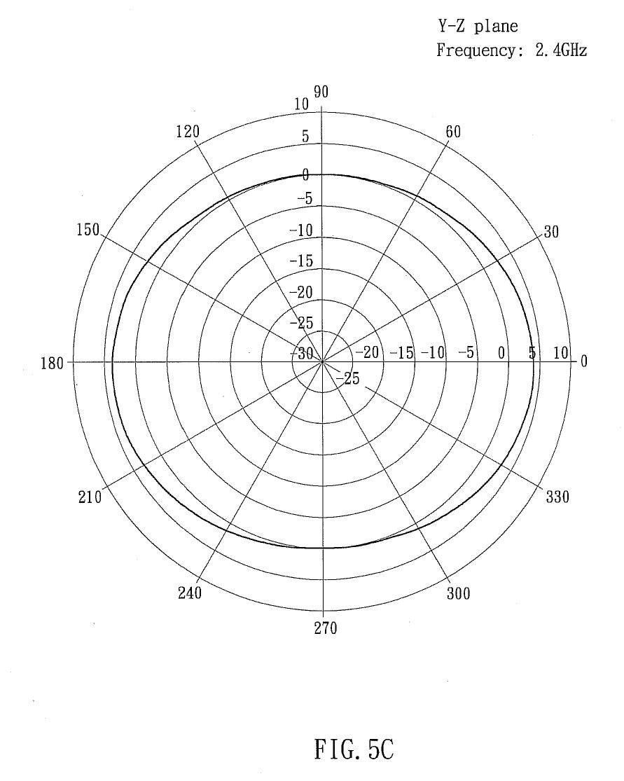

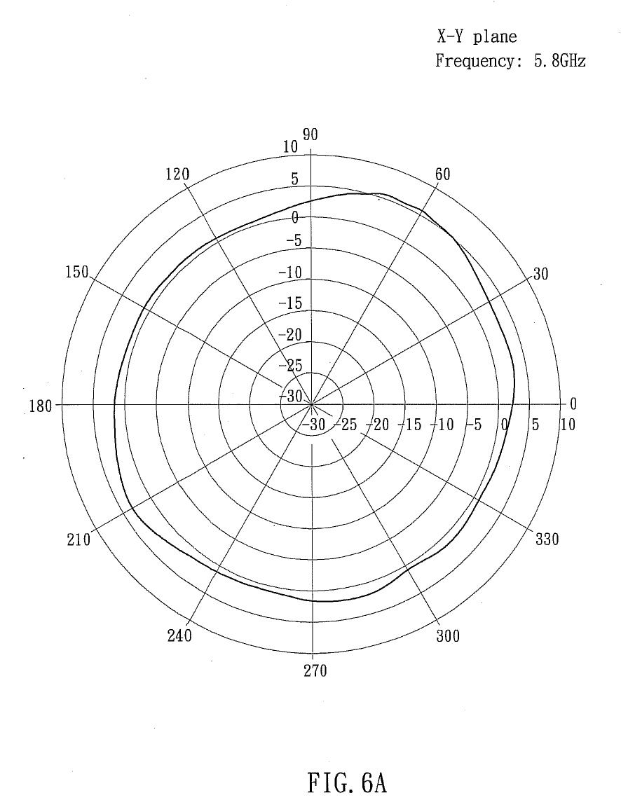

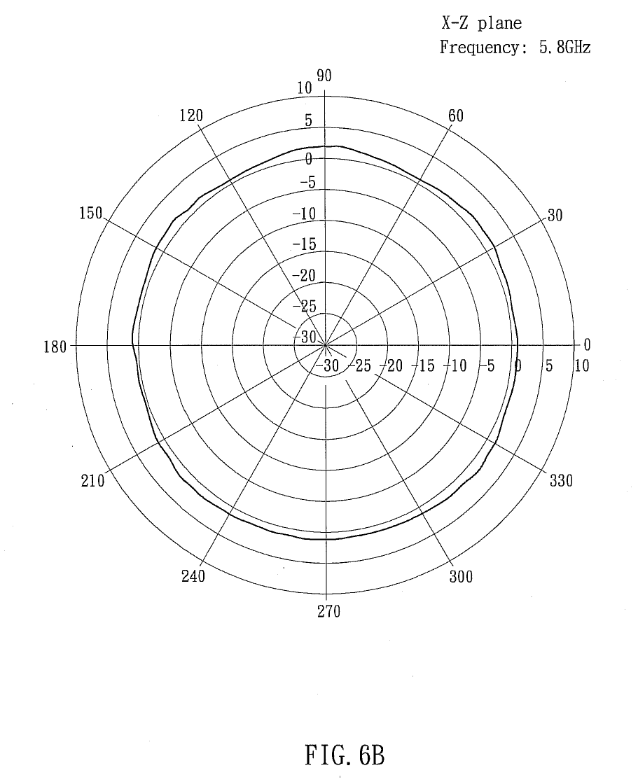

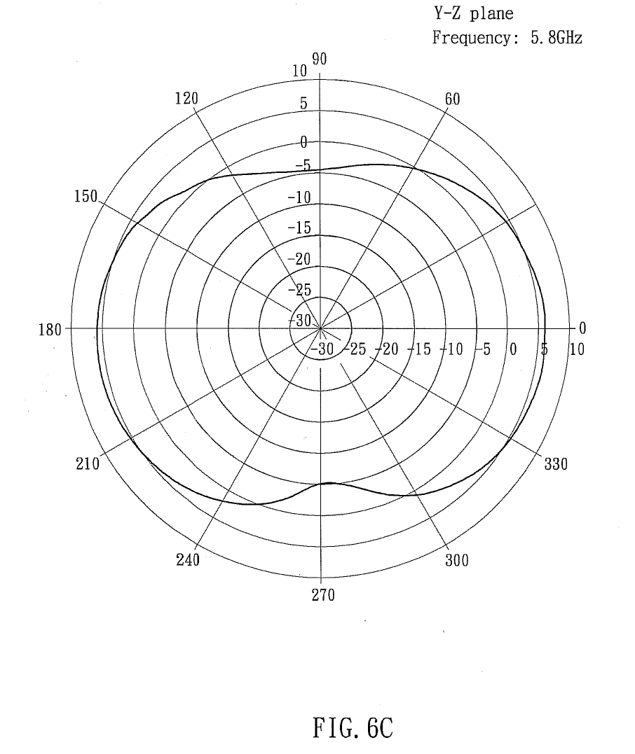

As shown in FIG. 4, the vertical axis shows the value of the Return Loss (dB), and the horizontal axis shows the value of the frequency. In consideration of the acceptable requirement of the Return Loss less than −10 dB, it may be observed from FIG. 4 that the dual-band antenna 2 of the preferred embodiment can operate in a bandwidth between 2.4 GHz and 2.5 GHz and another bandwidth between 5.2 GHz and 5.8 GHz. In addition, FIG. 5A to 5C and FIG. 6A to 6C show the radiation fields of the flat dual-bad antenna 2 when it operates at 2.4 GHz and 5.8 GHz, respectively. FIG. 5A to 5C show the radiation fields of X-Y plane, X-Z plane and Y-Z plane, respectively, when the flat dual-band antenna 2 operates at 2.4 GHz. FIG. 6A to 6C show the radiation fields of X-Y plane, X-Z plane and Y-Z plane, respectively, when the flat dual-band antenna 2 operates at 5.8 GHz.

In summary, the flat dual-band antenna of the invention modifies the relative locations of the feeding unit and the grounding unit, so that the first radiating portion and the grounding unit can operate in a first frequency band and the second radiating portion and the grounding unit can operate in a second frequency band. In addition, the impedance can be adjusted by the gradual width-changing section of the invention so as to increase the operating frequency bandwidth. Therefore, the flat dual-band antenna of the invention can operate in dual frequency bands and have larger bandwidth, thereby enhancing the transmission efficiency.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A flat dual-band antenna, comprising:
a radiating unit;
a grounding unit having a gradual width-changing section, wherein one end of the grounding unit is connected with the radiating unit, the other end of the grounding unit is grounded, and the radiating unit is divided into a first radiating portion and a second radiating portion by the grounding unit; and
a feeding unit connected with a junction of the first radiating portion and the second radiating portion and electrically connected with the radiating unit and the grounding unit.

2. The flat dual-band antenna according to claim 1, wherein the radiating unit has at least one bending portion.

3. The flat dual-band antenna according to claim 1, wherein the radiating unit is strip-shaped or L-shaped.

4. The flat dual-band antenna according to claim 1, wherein the grounding unit has at least one bending portion.

5. The flat dual-band antenna according to claim 1, wherein the width of the gradual width-changing section is gradually decreased.

6. The flat dual-band antenna according to claim 1, wherein the width of the gradual width-changing section is gradually increased.

7. The flat dual-band antenna according to claim 1, wherein the radiating unit and the feeding unit form a T shape.

8. The flat dual-band antenna according to claim 1, further comprising:
a conductive unit having a conductive body and a grounding body, wherein the conductive body is electrically connected with the feeding unit, and the grounding body is grounded.

9. The flat dual-band antenna according to claim 8, wherein the grounding body is connected with a grounding surface, and the grounding surface is connected with the grounding unit.

10. The flat dual-band antenna according to claim 8, wherein the conductive unit further has a first insulating layer and a second insulating layer, the first insulating layer is disposed between the conductive body and the grounding body, and the second insulating layer is a surface layer of the conductive unit.

11. The flat dual-band antenna according to claim 8, wherein the conductive unit is a coaxial transmission cable.

12. The flat dual-band antenna according to claim 1, wherein the first radiating portion and the grounding unit operate in a first frequency band, and the second radiating portion and the grounding unit operate in a second frequency band.

13. The flat dual-band antenna according to claim 12, wherein the first frequency band is compliant with IEEE 802.11b/g.

14. The flat dual-band antenna according to claim 12, wherein the first frequency band has a bandwidth between 2.4 GHz and 2.5 GHz.

15. The flat dual-band antenna according to claim 12, wherein the second frequency band is compliant with IEEE 802.11a.

16. The flat dual-band antenna according to claim 12, wherein the second frequency band has a bandwidth between 5.2 GHz and 5.8 GHz.

17. The flat dual-band antenna according to claim 1, further comprising:
a substrate, wherein the radiating unit, the grounding and the feeding unit are disposed on the substrate.

18. The flat dual-band antenna according to claim 17, wherein the substrate is a printed circuit board (PCB).

19. The flat dual-band antenna according to claim 1, wherein the radiating unit, the grounding unit and the feeding unit are integrally formed.
